(19) United States
(12) Patent Application Publication
(10) Pub. No.: US 2019/0141581 A1
(43) Pub. Date: May 9, 2019

(54) Method And Apparatus For Handling Back-Off Timer In Session Management Level Congestion Control

(71) Applicant: MediaTek Inc., Hsinchu City (TW)

(72) Inventors: Syue-Ju Syue, Hsinchu City (TW); Te-Huang Liu, Hsinchu City (TW)

(21) Appl. No.: 16/183,656

(22) Filed: Nov. 7, 2018

Related U.S. Application Data
(60) Provisional application No. 62/582,361, filed on Nov. 7, 2017.

(51) Int. Cl. H04W 36/00; H04W 28/02; H04W 76/18; H04W 76/14; H04L 29/12

(52) U.S. Cl. CPC H04W 36/0022; H04W 36/0033; H04L 61/3075; H04W 76/18; H04W 76/14; H04W 28/0273

(57) ABSTRACT

Various solutions for handling back-off timer in session management level congestion control with respect to user equipment and network apparatus in mobile communications are described. An apparatus may establish a first connection with a first packet data network (PDN) or packet data protocol (PDP) type. The apparatus may transmit a first request message with a second PDN or PDP type for establishing a second connection. The apparatus may receive a reject message with a reject cause. The apparatus may transmit a second request message for establishing the second connection without initiating a default back-off timer.

### CROSS REFERENCE TO RELATED PATENT APPLICATION(S)

The present disclosure is part of a non-provisional application claiming the priority benefit of U.S. Patent Application No. 62/582,361, filed on 7 Nov. 2017, the content of which is incorporated by reference in its entirety.

### TECHNICAL FIELD

The present disclosure is generally related to mobile communications and, more particularly, to handling back-off timer in session management level congestion control with respect to user equipment and network apparatus in mobile communications.

### BACKGROUND

Unless otherwise indicated herein, approaches described in this section are not prior art to the claims listed below and are not admitted as prior art by inclusion in this section.

Based on the 3^{rd} generation partnership project (3GPP) specifications, when the user equipment (UE) establishes a session with the network apparatus, the network apparatus may include a back-off timer value in a session management reject message to regulate the time interval within which the UE is not allowed to retry the same procedure. Alternatively, even if no back-off timer value is included in the session management reject message, the UE may also be configured to initiate a back-off timer with a default value.

The back-off timer may be used for session management level congestion control. The back-off timer may block the subsequent requests from upper layer for establishing a connection. For example, in a communication network, it is possible that an Internet Protocol (IP) address allocation mechanism via non-access stratum (NAS) signaling may cause that the UE temporarily cannot use certain data services. This is because some networks may not allow a certain packet data network (PDN) or packet data protocol (PDP) type for a PDN connection or PDP context establishment and may send a reject message to the UE with some improper reject causes. As a consequence, the UE may be block out and may not be able to get data services for a certain time period due to the back-off timer.

Accordingly, how to properly handle the back-off timer to avoid unnecessary barring from acquiring data services from the network apparatus may affect UE's performance and the user experiences. It is needed to provide proper design for determining whether to activate the back-off timer under certain scenarios.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to handling back-off timer in session management level congestion control with respect to user equipment and network apparatus in mobile communications.

In one aspect, a method may involve an apparatus establishing a first connection with a first PDN or PDP type. The method may also involve the apparatus transmitting a first request message with a second PDN or PDP type for establishing a second connection. The method may further involve the apparatus receiving a reject message with a reject cause. The method may further involve the apparatus transmitting a second request message for establishing the second connection without initiating a default back-off timer.

In one aspect, an apparatus may comprise a transceiver capable of wirelessly communicating with a plurality of nodes of a wireless network. The apparatus may also comprise a processor communicatively coupled to the transceiver. The processor may be capable of establishing a first connection with a first PDN or PDP type. The processor may also be capable of transmitting a first request message with a second PDN or PDP type for establishing a second connection. The processor may further be capable of receiving a reject message with a reject cause. The processor may further be capable of transmitting a second request message for establishing the second connection without initiating a default back-off timer.

It is noteworthy that, although description provided herein may be in the context of certain radio access technologies, networks and network topologies such as Global System for Mobile communications (GSM), Universal Mobile Telecommunications System (UMTS), Long-Term Evolution (LTE), LTE-Advanced, LTE-Advanced Pro, 5th Generation (5G) and New Radio (NR), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a block diagram of an example communication apparatus and an example network apparatus in accordance with an implementation of the present disclosure.

FIG. 4 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to handling back-off timer in session management level congestion control with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

Based on the 3GPP specification, when the UE establishes a session with the network apparatus, the network apparatus may include a back-off timer value in a session management reject message to regulate the time interval within which the UE is not allowed to retry the same procedure. Alternatively, even if no back-off timer value is included in the session management reject message, the UE may also be configured to initiate a back-off timer with a default value. The back-off timer may be used for session management level congestion control. The back-off timer may block the subsequent requests from upper layer for establishing a connection. For example, in a communication network, it is possible that an IP address allocation mechanism via NAS signaling may cause that the UE temporarily cannot use certain data services. This is because some networks may not allow a certain PDN or PDP type for a PDN connection or PDP context establishment and may send a reject message to the UE with some improper reject causes. As a consequence, the UE may be block out and may not be able to get data services for a certain time period.

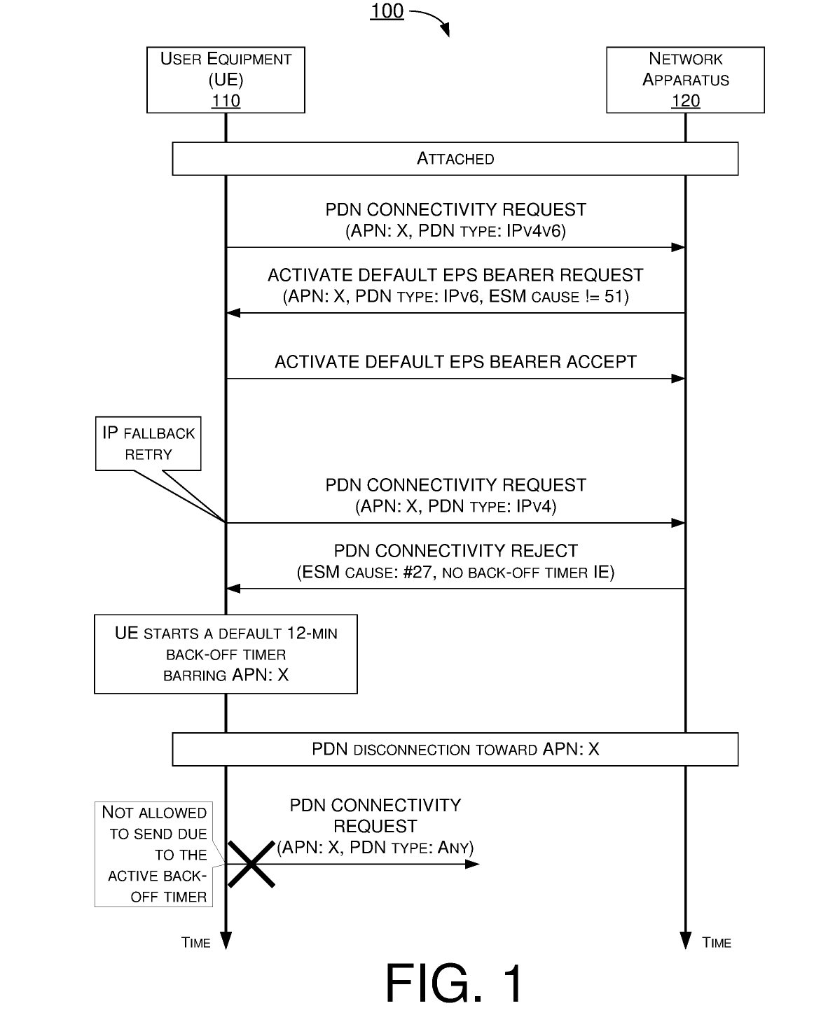

FIG. 1 illustrates an example scenario 100 in accordance with implementations of the present disclosure. Scenario 100 may involve UE 110 and network apparatus 120, which may be a part of a wireless communication network (e.g., a GSM network, a UMTS network, an LTE network, an LTE-Advanced network, an LTE-Advanced Pro network, a 5G network or an NR network). UE 110 may be configured to perform attach procedures to attach to network apparatus 120. In the attach procedures, UE 110 may be configured to establish a PDN or PDP connection with network apparatus 120. The PDN connection may be used for the LTE networks. The PDP connection may be used for the GSM or UMTS networks.

In order to acquire IP services or evolved packet system (EPS) services such as, for example and without limitations, Voice over LTE (VoLTE), UE 110 may be configured to establish additional PDN/PDP connections with network apparatus 120. Specifically, UE 110 may be configured to transmit a request message for establishing a PDN/PDP connection. The request message may comprise a PDN CONNECTIVITY REQUEST message for establishing the PDN connection or an ACTIVATE PDP CONTEXT REQUEST message for establishing the PDP connection. In the request message, UE 110 may specify an access point name (APN) (e.g., APN: X) and a PDN/PDP type for establishing the PDN/PDP connection and acquiring the IP address. The PDN/PDP type may comprise, for example and without limitations, an Internet Protocol version 4 (IPv4), an IPv6 or an IPv4v6. In a case that UE 110 supports only IPv4, UE 110 may specify IPv4 in the PDN/PDP type IE. In a case that UE 110 supports only IPv6, UE 110 may specify IPv6 in the PDN/PDP type IE. In a case that UE 110 supports both IPv4 and IPv6, UE 110 may specify IPv4v6 in the PDN/PDP type IE.

After receiving the request message, network apparatus 120 may transmit a response message to UE 110. The response message may comprise an ACTIVATE DEFAULT EPS BEARER REQUEST message or an ACTIVATE PDP CONTEXT ACCEPT message. In the response message, network apparatus 120 may specify the APN, the supported PDN/PDP type and an EPS session management (ESM) or SM cause. In a case that the connectivity with the requested PDN type is accepted, but with a restriction of IP version, an ESM cause shall be included in the ACTIVATE DEFAULT EPS BEARER REQUEST message. For example, both an IPv4 address and an IPv6 prefix may be requested by UE 110, but only one particular IP version or only single IP version bearer may be supported/allowed by network apparatus 120. In such case, the ESM cause may comprise ESM cause #50 which representing “PDN type IPv4 only allowed”, ESM cause #51 which representing “PDN type IPv6 only allowed”, or ESM cause #52 which representing “single address bearers only allowed”.

Alternatively, in a case that a mobile station (MS) (e.g., UE 110) requests PDP type IPv4v6, but the network configuration dictates the use of IPv4 addressing only or IPv6 addressing only for this APN, the network (e.g., network apparatus 120) shall override the PDP type requested by the MS to a single address PDP type (e.g., IPv4 or IPv6). In the ACTIVATE PDP CONTEXT ACCEPT message sent to the MS, the network may set the PDP type number to either “IPv4 address” or “IPv6 address” and the SM cause to SM cause #50 which representing “PDP type IPv4 only allowed” or SM cause #51 which representing “PDP type IPv6 only allowed” respectively.

After receiving the ACTIVATE DEFAULT EPS BEARER REQUEST message, UE 110 may be configured to further transmit an ACTIVATE DEFAULT EPS BEARER ACCEPT message to network apparatus 120 to finish the connection establishment. In a case that network apparatus 120 does not support/allow both IP version (e.g., IPv4 and IPv6), only single IP version connection may be established (e.g., either IPv4 or IPv6) after the connection establishment procedures.

In some implementations, network apparatus 120 may not clearly specify the proper ESM/SM case in the ACTIVATE DEFAULT EPS BEARER REQUEST message or the ACTIVATE PDP CONTEXT ACCEPT message. For example, in a case that network apparatus 120 only support/allow the IPv6, network apparatus 120 may not carry any ESM/SM cause or may only carry the ESM/SM cause #52 which representing “single address bearers only allowed”. In other words, network apparatus 120 may not clearly indicate that it does not support/allow the IPv6 (i.e., the ESM/SM cause is not equal to cause #51). In such scenario, UE 110 may be configured to perform IP fallback retry procedures. UE 110 may try to re-establish the PDN connection for IPv4. Specifically, UE 110 may be configured to further transmit a request message (e.g., a PDN CONNECTIVITY REQUEST message or an ACTIVATE PDP CONTEXT REQUEST message) to network apparatus 120 for establishing a PDN/PDP connection of IPv4. In the request message, UE 110 may specify the same APN (e.g., APN: X) and change the PDN/PDP type to IPv4.

However, since network apparatus 120 may not support/allow the IPv4, network apparatus 120 may be configured to transmit a reject message to UE 110. The reject message may comprise a PDN CONNECTIVITY REJECT message or an ACTIVATE PDP CONTEXT REJECT message. In the reject message, network apparatus 120 may specify an ESM/SM cause. The ESM/SM cause may comprise cause #8 which representing “operator determined barring”, cause #27 which representing “missing or unknown APN”, cause #32 which representing “service option not supported”, or cause #33 which representing “requested service option not subscribed”. The reject message may comprise no back-off timer information element.

Network apparatus 120 may use the reject message to block UE 110 from acquiring services for a period of time. After receiving the reject message with the specified ESM/SM cause, UE 110 may be configured to initiate a default back-off timer. The default back-off timer may comprise a predetermined timer value (e.g., 12 minutes). The predetermined timer value may be stored in a subscriber identity module (SIM) configuration or a predetermined default value. UE 110 may not be allowed to transmit any request message (e.g., a PDN CONNECTIVITY REQUEST message or an ACTIVATE PDP CONTEXT REQUEST message) to network apparatus 120 before the expiration of the default back-off timer. Accordingly, even when the PDN/PDP connection toward APN X is disconnected, UE 110 may still not be able to establish a new PDN/PDP connection toward APN X due to the active back-off timer.

In view of the above, the present disclosure proposes a number of schemes pertaining to handling the default back-off timer. According to the schemes of the present disclosure, the default back-off time should not be initiated under some conditions. Since the network apparatus may not send the reject causes properly, the UE should not be barred from acquiring services due to the improper reject causes.

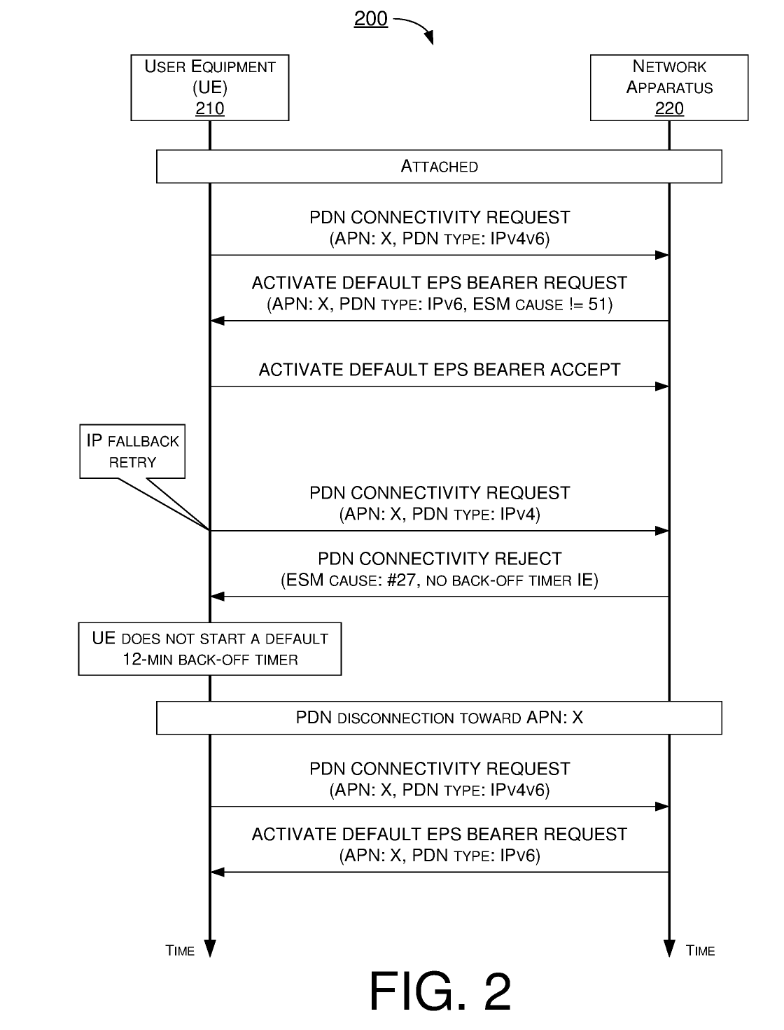

FIG. 2 illustrates an example scenario 200 in accordance with implementations of the present disclosure. Scenario 200 may involve UE 210 and network apparatus 220, which may be a part of a wireless communication network (e.g., a GSM network, a UMTS network, an LTE network, an LTE-Advanced network, an LTE-Advanced Pro network, a 5G network or an NR network). UE 210 may be configured to perform attach procedures to attach to network apparatus 220. In the attach procedures, UE 210 may be configured to establish a PDN or PDP connection with network apparatus 220. The PDN connection may be used for the LTE networks. The PDP connection may be used for the GSM or UMTS networks.

In order to acquire IP services or EPS services (e.g., VoLTE), UE 210 may be configured to establish additional PDN/PDP connections with network apparatus 220. Specifically, UE 210 may be configured to transmit a request message for establishing a PDN/PDP connection. The request message may comprise a PDN CONNECTIVITY REQUEST message for establishing the PDN connection or an ACTIVATE PDP CONTEXT REQUEST message for establishing the PDP connection. In the request message, UE 210 may specify an APN (e.g., APN: X) and a PDN/PDP type for establishing the PDN/PDP connection and acquiring the IP address. The PDN/PDP type may comprise, for example and without limitations, an IPv4, an IPv6 or an IPv4v6. In a case that UE 210 supports only IPv4, UE 210 may specify IPv4 in the PDN/PDP type IE. In a case that UE 210 supports only IPv6, UE 210 may specify IPv6 in the PDN/PDP type IE. In a case that UE 210 supports both IPv4 and IPv6, UE 210 may specify IPv4v6 in the PDN/PDP type IE.

After receiving the request message, network apparatus 220 may transmit a response message to UE 210. The response message may comprise an ACTIVATE DEFAULT EPS BEARER REQUEST message or an ACTIVATE PDP CONTEXT ACCEPT message. In the response message, network apparatus 220 may specify the APN, the supported PDN/PDP type and an ESM or SM cause.

After receiving the ACTIVATE DEFAULT EPS BEARER REQUEST message, UE 210 may be configured to further transmit an ACTIVATE DEFAULT EPS BEARER ACCEPT message to network apparatus 220 to finish the connection establishment. In a case that network apparatus 220 does not support/allow both IP version (e.g., IPv4 and IPv6), only single IP version connection may be established (e.g., either IPv4 or IPv6) after the connection establishment procedures. Specifically, only a first connection with a first PDN/PDP type may be established. For example, in a case that network apparatus 220 only supports/allows IPv6, only the PDN/PDP connection for IPv6 may be established. Alternatively, in a case that network apparatus 220 only supports/allows IPv4, only the PDN/PDP connection for IPv4 may be established.

In some implementations, network apparatus 220 may not clearly specify the proper ESM/SM case in the ACTIVATE DEFAULT EPS BEARER REQUEST message or the ACTIVATE PDP CONTEXT ACCEPT message. For example, in a case that network apparatus 220 only support/allow the IPv6, network apparatus 220 may not carry any ESM/SM cause or may only carry the ESM/SM cause #52 which representing “single address bearers only allowed”. In other words, network apparatus 220 may not clearly indicate that it does not support/allow the IPv6 (i.e., the ESM/SM cause is not equal to cause #51). In such scenario, UE 210 may be configured to perform IP fallback retry procedures. UE 210 may try to establish a second PDN/PDP connection with a second PDN/PDP type. Specifically, UE 210 may be configured to further transmit a first request message (e.g., a PDN CONNECTIVITY REQUEST message or an ACTIVATE PDP CONTEXT REQUEST message) to network apparatus 220 for establishing a PDN/PDP connection with IPv4. In the request message, UE 210 may specify the same APN (e.g., APN: X) and change the PDN/PDP type to IPv4.

Alternatively, in a case that network apparatus 220 only support/allow the IPv4, network apparatus 220 may not carry any ESM/SM cause or may only carry the ESM/SM cause #52 which representing “single address bearers only allowed”. In other words, network apparatus 220 may not clearly indicate that it does not support/allow the IPv4 (i.e., the ESM/SM cause is not equal to cause #50). In such scenario, UE 210 may be configured to perform IP fallback retry procedures. UE 210 may try to establish a second PDN/PDP connection for a second PDN/PDP type. Specifically, UE 210 may be configured to further transmit a request message (e.g., a PDN CONNECTIVITY REQUEST message or an ACTIVATE PDP CONTEXT REQUEST message) to network apparatus 220 for establishing a PDN/PDP connection with IPv6. In the request message, UE 210 may specify the same APN (e.g., APN: X) and change the PDN/PDP type to IPv6.

However, since network apparatus 220 may not support/allow the requested PDN/PDP type (e.g., IPv4 or IPv6), network apparatus 220 may be configured to transmit a reject message to UE 210. The reject message may comprise a PDN CONNECTIVITY REJECT message or an ACTIVATE PDP CONTEXT REJECT message. In the reject message, network apparatus 220 may specify a reject cause (e.g., ESM/SM cause). The reject cause may comprise cause #8 which representing “operator determined barring”, cause #27 which representing “missing or unknown APN”, cause #32 which representing “service option not supported”, or cause #33 which representing “requested service option not subscribed”. The reject message may comprise no back-off timer information element.

After receiving the reject message, UE 210 may be configured to determine whether the IP fallback retry is detected and whether a specific reject cause is received. The IP fallback retry may be detected by determining that after a first PDN/PDP connection with a first PDN/PDP type (e.g., IPv4 or IPv6) is established, UE 210 may further try to establish a second PDN/PDP connection with a second PDN/PDP type (e.g., IPv6 or IPv4) for the same APN. The second PDN/PDP type may be different from the first PDN/PDP type. The specific reject cause may comprise cause #8, cause #27, cause #32 or cause #33. Once the IP fallback retry is detected and the specific reject cause is received, UE 210 may be configured not to initiate the default back-off timer. The specific reject cause (e.g., cause #8, cause #27, cause #32 or cause #33) may not properly reflect that the request message is rejected due to the unsupported IP version at network apparatus 220. In a case that UE 210 initiates the default back-off timer, UE 210 may be blocked from transmitting any further request message and may lose the chance for establishing a PDN/PDP connection based on the supported IP version.

Without initiating the default back-off timer, UE 210 may be able to transmit a second request message (e.g., a PDN CONNECTIVITY REQUEST message or an ACTIVATE PDP CONTEXT REQUEST message) to network apparatus 220 for establishing a second PDN/PDP connection shortly. Network apparatus 220 may also be able to reply a response message (e.g., an ACTIVATE DEFAULT EPS BEARER REQUEST message or an ACTIVATE PDP CONTEXT ACCEPT message) for establishing a new PDN/PDP connection. For example, after a first VoLTE call (e.g., a first PDN/PDP connection) is disconnected, UE 210 may be able to establish a second VoLTE call (e.g., a second PDN/PDP connection) shortly without waiting for the block period of the default back-off timer. Accordingly, UE 210 may not be barred from acquiring services for a period of time due to the improper reject causes received from network apparatus 220.

### Illustrative Implementations

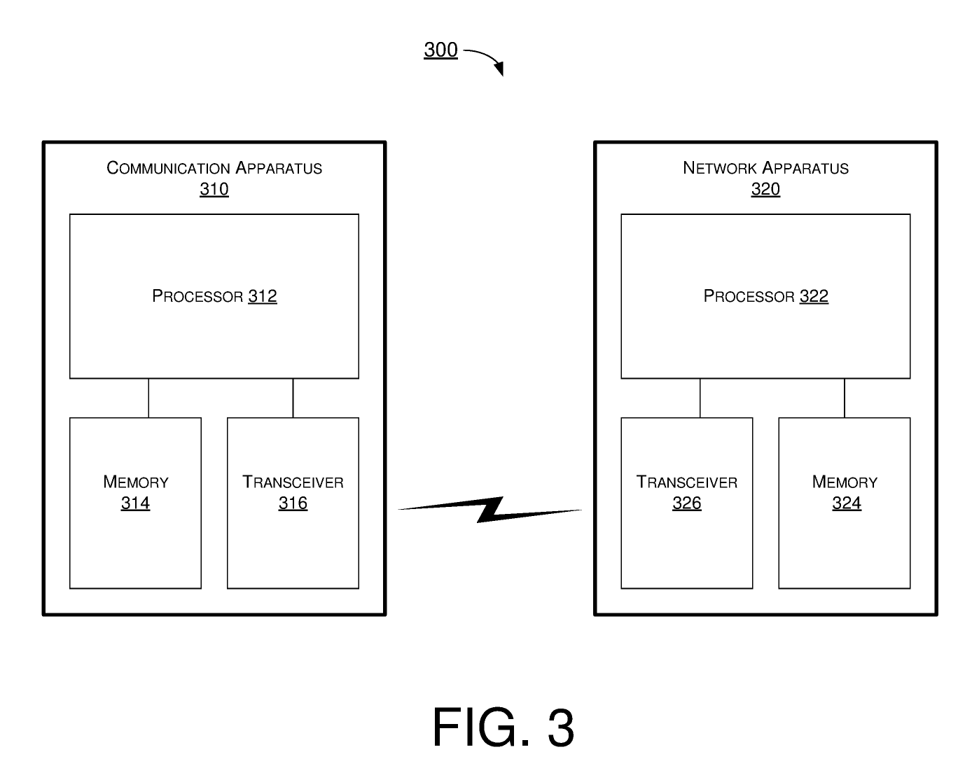

FIG. 3 illustrates an example communication apparatus 310 and an example network apparatus 320 in accordance with an implementation of the present disclosure. Each of communication apparatus 310 and network apparatus 320 may perform various functions to implement schemes, techniques, processes and methods described herein pertaining to handling back-off timer in session management level congestion control with respect to user equipment and network apparatus in wireless communications, including schemes described above as well as process 400 described below.

Communication apparatus 310 may be a part of an electronic apparatus, which may be a UE such as a portable or mobile apparatus, a wearable apparatus, a wireless communication apparatus or a computing apparatus. For instance, communication apparatus 310 may be implemented in a smartphone, a smartwatch, a personal digital assistant, a digital camera, or a computing equipment such as a tablet computer, a laptop computer or a notebook computer. Communication apparatus 310 may also be a part of a machine type apparatus, which may be an IoT or NB-IoT apparatus such as an immobile or a stationary apparatus, a home apparatus, a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, or one or more complex-instruction-set-computing (CISC) processors. Communication apparatus 310 may include at least some of those components shown in FIG. 3 such as a processor 312, for example. Communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of an electronic apparatus, which may be a network node such as a base station, a small cell, a router or a gateway. For instance, network apparatus 320 may be implemented in a base station in a GSM or UMTS network, in an eNodeB in an LTE, LTE-Advanced or LTE-Advanced Pro network or in a gNB in a 5G, NR, IoT or NB-IoT network. Alternatively, network apparatus 320 may be implemented in the form of one or more IC chips such as, for example and without limitation, one or more single-core processors, one or more multi-core processors, or one or more CISC processors. Network apparatus 320 may include at least some of those components shown in FIG. 3 such as a processor 322, for example. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including handling back-off timer in session management level congestion control with respect to user equipment and network apparatus in mobile communications in accordance with various implementations of the present disclosure.

In some implementations, communication apparatus 310 may also include a transceiver 316 coupled to processor 312 and capable of wirelessly transmitting and receiving data. In some implementations, communication apparatus 310 may further include a memory 314 coupled to processor 312 and capable of being accessed by processor 312 and storing data therein. In some implementations, network apparatus 320 may also include a transceiver 326 coupled to processor 322 and capable of wirelessly transmitting and receiving data. In some implementations, network apparatus 320 may further include a memory 324 coupled to processor 322 and capable of being accessed by processor 322 and storing data therein. Accordingly, communication apparatus 310 and network apparatus 320 may wirelessly communicate with each other via transceiver 316 and transceiver 326, respectively. To aid better understanding, the following description of the operations, functionalities and capabilities of each of communication apparatus 310 and network apparatus 320 is provided in the context of a mobile communication environment in which communication apparatus 310 is implemented in or as a communication apparatus or a UE and network apparatus 320 is implemented in or as a network node of a communication network.

In some implementations, processor 312 may be configured to perform attach procedures to attach to network apparatus 320. In the attach procedures, processor 312 may be configured to establish, via transceiver 316, a PDN or PDP connection with network apparatus 320. The PDN connection may be used for the LTE networks. The PDP connection may be used for the GSM or UMTS networks.

In some implementations, in order to acquire IP services or EPS services (e.g., VoLTE), processor 312 may be configured to establish, via transceiver 316, additional PDN/PDP connections with network apparatus 320. Specifically, processor 312 may be configured to transmit, via transceiver 316, a request message for establishing a PDN/PDP connection. Processor 312 may transmit a PDN CONNECTIVITY REQUEST message for establishing the PDN connection or an ACTIVATE PDP CONTEXT REQUEST message for establishing the PDP connection. In the request message, processor 312 may specify an APN and a PDN/PDP type for establishing the PDN/PDP connection and acquiring the IP address. The PDN/PDP type may comprise, for example and without limitations, an IPv4, an IPv6 or an IPv4v6. In a case that communication apparatus 310 supports only IPv4, processor 312 may specify IPv4 in the PDN/PDP type IE. In a case that communication apparatus 310 supports only IPv6, processor 312 may specify IPv6 in the PDN/PDP type IE. In a case that communication apparatus 310 supports both IPv4 and IPv6, processor 312 may specify IPv4v6 in the PDN/PDP type IE.

In some implementations, after receiving the request message, processor 322 may transmit, via transceiver 326, a response message to communication apparatus 310. Processor 322 may transmit an ACTIVATE DEFAULT EPS BEARER REQUEST message or an ACTIVATE PDP CONTEXT ACCEPT message. In the response message, processor 322 may specify the APN, the supported PDN/PDP type and an ESM or SM cause.

In some implementations, after receiving the ACTIVATE DEFAULT EPS BEARER REQUEST message, processor 312 may be configured to further transmit an ACTIVATE DEFAULT EPS BEARER ACCEPT message to network apparatus 320 to finish the connection establishment. In a case that network apparatus 320 does not support/allow both IP version (e.g., IPv4 and IPv6), processor 312 may only establish single IP version connection (e.g., either IPv4 or IPv6) after the connection establishment procedures. Specifically, processor 312 may only establish a first connection with a first PDN/PDP type. For example, in a case that network apparatus 320 only supports/allows IPv6, processor 312 may only establish the PDN/PDP connection for IPv6. Alternatively, in a case that network apparatus 320 only supports/allows IPv4, processor 312 may only establish the PDN/PDP connection for IPv4.

In some implementations, network apparatus 320 may not clearly specify the proper ESM/SM case in the ACTIVATE DEFAULT EPS BEARER REQUEST message or the ACTIVATE PDP CONTEXT ACCEPT message. For example, in a case that network apparatus 320 only support/allow the IPv6, processor 322 may not send any ESM/SM cause or may only send the ESM/SM cause #52 which representing “single address bearers only allowed”. In other words, network apparatus 320 may not clearly indicate that it does not support/allow the IPv6 (i.e., the ESM/SM cause is not equal to cause #51). In such scenario, processor 312 may be configured to perform IP fallback retry procedures. Processor 312 may try to establish a second PDN/PDP connection with a second PDN/PDP type. Specifically, processor 312 may be configured to further transmit, via transceiver 316, a first request message (e.g., a PDN CONNECTIVITY REQUEST message or an ACTIVATE PDP CONTEXT REQUEST message) to network apparatus 320 for establishing a PDN/PDP connection with IPv4. In the request message, processor 312 may specify the same APN and change the PDN/PDP type to IPv4.

In some implementations, in a case that network apparatus 320 only support/allow the IPv4, processor 322 may not send any ESM/SM cause or may only send the ESM/SM cause #52 which representing “single address bearers only allowed”. In other words, network apparatus 320 may not clearly indicate that it does not support/allow the IPv4 (i.e., the ESM/SM cause is not equal to cause #50). In such scenario, processor 312 may be configured to perform IP fallback retry procedures. Processor 312 may try to establish a second PDN/PDP connection for a second PDN/PDP type. Specifically, processor 312 may be configured to further transmit, via transceiver 316, a request message (e.g., a PDN CONNECTIVITY REQUEST message or an ACTIVATE PDP CONTEXT REQUEST message) to network apparatus 320 for establishing a PDN/PDP connection with IPv6. In the request message, processor 312 may specify the same APN and change the PDN/PDP type to IPv6.

In some implementations, since network apparatus 320 may not support/allow the requested PDN/PDP type (e.g., IPv4 or IPv6), processor 322 may be configured to transmit, via transceiver 326, a reject message to communication apparatus 310. The reject message may comprise a PDN CONNECTIVITY REJECT message or an ACTIVATE PDP CONTEXT REJECT message. In the reject message, processor 322 may specify a reject cause (e.g., ESM/SM cause). The reject cause may comprise cause #8 which representing “operator determined barring”, cause #27 which representing “missing or unknown APN”, cause #32 which representing “service option not supported”, or cause #33 which representing “requested service option not subscribed”. The reject message may comprise no back-off timer information element.

In some implementations, after receiving the reject message, processor 312 may be configured to determine whether the IP fallback retry is detected and whether a specific reject cause is received. Processor 312 may detect the IP fallback retry by determining that after a first PDN/PDP connection with a first PDN/PDP type (e.g., IPv4 or IPv6) is established, processor 312 may further try to establish a second PDN/PDP connection with a second PDN/PDP type (e.g., IPv6 or IPv4) for the same APN. The second PDN/PDP type may be different from the first PDN/PDP type. The specific reject cause may comprise cause #8, cause #27, cause #32 or cause #33. Once the IP fallback retry is detected and the specific reject cause is received, processor 312 may be configured not to initiate the default back-off timer. The specific reject cause (e.g., cause #8, cause #27, cause #32 or cause #33) may not properly reflect that the request message is rejected due to the unsupported IP version at network apparatus 320. In a case that processor 312 initiates the default back-off timer, processor 312 may be blocked from transmitting any further request message and may lose the chance for establishing a PDN/PDP connection based on the supported IP version.

In some implementations, without initiating the default back-off timer, processor 312 may be able to transmit a second request message (e.g., a PDN CONNECTIVITY REQUEST message or an ACTIVATE PDP CONTEXT REQUEST message) to network apparatus 220 for establishing a second PDN/PDP connection shortly. Network apparatus 320 may also be able to reply a response message (e.g., an ACTIVATE DEFAULT EPS BEARER REQUEST message or an ACTIVATE PDP CONTEXT ACCEPT message) for establishing a new PDN/PDP connection. For example, after a first VoLTE call (e.g., a first PDN/PDP connection) is disconnected, processor 312 may be able to establish a second VoLTE call (e.g., a second PDN/PDP connection) shortly without waiting for the block period of the default back-off timer. Accordingly, communication apparatus 310 may not be barred from acquiring services for a period of time due to the improper reject causes received from network apparatus 320.

### Illustrative Processes

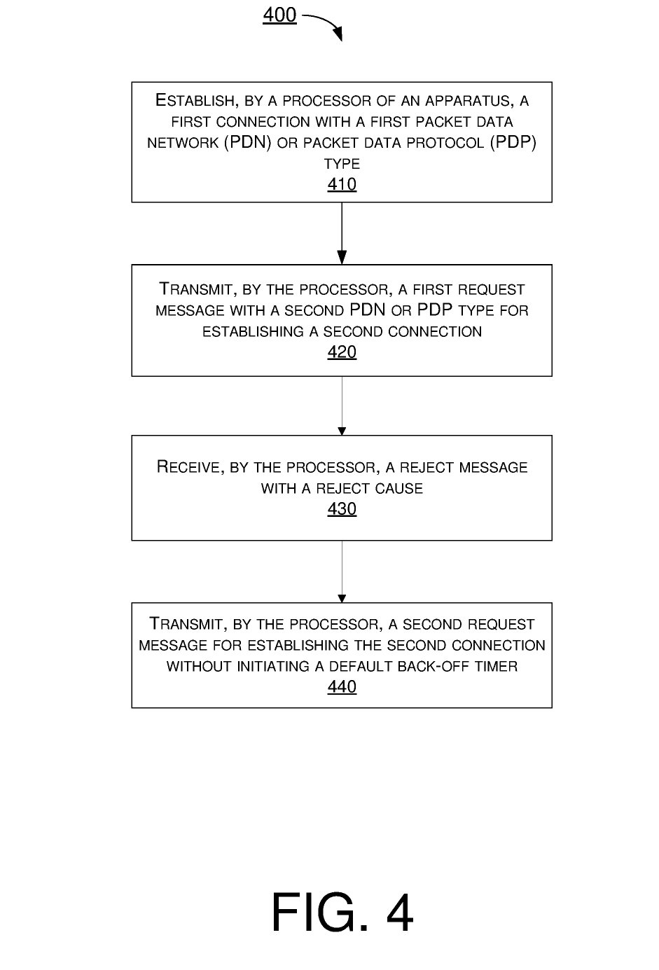

FIG. 4 illustrates an example process 400 in accordance with an implementation of the present disclosure. Process 400 may be an example implementation of scenarios described above, whether partially or completely, with respect to handling back-off timer in session management level congestion control in accordance with the present disclosure. Process 400 may represent an aspect of implementation of features of communication apparatus 310. Process 400 may include one or more operations, actions, or functions as illustrated by one or more of blocks 410, 420, 430 and 440. Although illustrated as discrete blocks, various blocks of process 400 may be divided into additional blocks, combined into fewer blocks, or eliminated, depending on the desired implementation. Moreover, the blocks of process 400 may executed in the order shown in FIG. 4 or, alternatively, in a different order. Process 400 may be implemented by communication apparatus 310 or any suitable UE or machine type devices. Solely for illustrative purposes and without limitation, process 400 is described below in the context of communication apparatus 310. Process 400 may begin at block 410.

At 410, process 400 may involve processor 312 of communication apparatus 310 establishing a first connection with a first PDN or PDP type. Process 400 may proceed from 410 to 420.

At 420, process 400 may involve processor 312 transmitting a first request message with a second PDN or PDP type for establishing a second connection. Process 400 may proceed from 420 to 430.

At 430, process 400 may involve processor 312 receiving a reject message with a reject cause. Process 400 may proceed from 430 to 440.

At 440, process 400 may involve processor 312 transmitting a second request message for establishing the second connection without initiating a default back-off timer.

In some implementations, the second PDN or PDP type may be different from the first PDN or PDP type.

In some implementations, an APN of the second connection may be identical to an APN of the first connection.

In some implementations, the default back-off timer may comprise a predetermined timer value (e.g., 12 minutes). The predetermined timer value may be stored in a SIM configuration or a predetermined default value.

In some implementations, the reject cause may comprise cause #8, cause #27, cause #32 or cause #33.

In some implementations, the reject message may comprise no back-off timer information element.

In some implementations, the first connection or the second connection may comprise a PDN connection or a PDP connection.

In some implementations, the first PDN or PDP type or the second PDN or PDP type may comprise an IPv4, an IPv6 or an IPv4v6.

In some implementations, the first request message or the second request message may comprise a PDN CONNECTIVITY REQUEST message or an ACTIVATE PDP CONTEXT REQUEST message.

In some implementations, the reject message may comprise a PDN CONNECTIVITY REJECT message or an ACTIVATE PDP CONTEXT REJECT message.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
establishing, by a processor of an apparatus, a first connection with a first packet data network (PDN) or packet data protocol (PDP) type;
transmitting, by the processor, a first request message with a second PDN or PDP type for establishing a second connection;
receiving, by the processor, a reject message with a reject cause; and
transmitting, by the processor, a second request message for establishing the second connection without initiating a default back-off timer.

2. The method of claim 1, wherein the second PDN or PDP type is different from the first PDN or PDP type.

3. The method of claim 1, wherein an access point name (APN) of the second connection is identical to an APN of the first connection.

4. The method of claim 1, wherein the default back-off timer comprises a predetermined timer value.

5. The method of claim 1, wherein the reject cause comprises cause #8, cause #27, cause #32 or cause #33.

6. The method of claim 1, wherein the reject message comprises no back-off timer information element.

7. The method of claim 1, wherein the first connection or the second connection comprises a PDN connection or a PDP connection.

8. The method of claim 1, wherein the first PDN or PDP type or the second PDN or PDP type comprises an Internet Protocol version 4 (IPv4), an IPv6 or an IPv4v6.

9. The method of claim 1, wherein the first request message or the second request message comprises a PDN CONNECTIVITY REQUEST message or an ACTIVATE PDP CONTEXT REQUEST message.

10. The method of claim 1, wherein the reject message comprises a PDN CONNECTIVITY REJECT message or an ACTIVATE PDP CONTEXT REJECT message.

11. An apparatus, comprising:
a transceiver capable of wirelessly communicating with a plurality of nodes of a wireless network; and
a processor communicatively coupled to the transceiver, the processor capable of:
establishing, via the transceiver, a first connection with a first packet data network (PDN) or packet data protocol (PDP) type;
transmitting, via the transceiver, a first request message with a second PDN or PDP type for establishing a second connection;
receiving, via the transceiver, a reject message with a reject cause; and
transmitting, via the transceiver, a second request message for establishing the second connection without initiating a default back-off timer.

12. The apparatus of claim 11, wherein the second PDN or PDP type is different from the first PDN or PDP type.

13. The apparatus of claim 11, wherein an access point name (APN) of the second connection is identical to an APN of the first connection.

14. The apparatus of claim 11, wherein the default back-off timer comprises a predetermined timer value.

15. The apparatus of claim 11, wherein the reject cause comprises cause #8, cause #27, cause #32 or cause #33.

16. The apparatus of claim 11, wherein the reject message comprises no back-off timer information element.

17. The apparatus of claim 11, wherein the first connection or the second connection comprises a PDN connection or a PDP connection.

18. The apparatus of claim 11, wherein the first PDN or PDP type or the second PDN or PDP type comprises an Internet Protocol version 4 (IPv4), an IPv6 or an IPv4v6.

19. The apparatus of claim 11, wherein the first request message or the second request message comprises a PDN CONNECTIVITY REQUEST message or an ACTIVATE PDP CONTEXT REQUEST message.

20. The apparatus of claim 11, wherein the reject message comprises a PDN CONNECTIVITY REJECT message or an ACTIVATE PDP CONTEXT REJECT message.
